(19) United States
(12) Patent Application Publication
(10) Pub. No.: US 2017/0294787 A1
(43) Pub. Date: Oct. 12, 2017

(54) CHARGER TERMINAL AND CHARGER

(71) Applicant: MAKITA CORPORATION, Anjo-shi (JP)

(72) Inventor: Hideyuki TAGA, Anjo-Shi (JP)

(73) Assignee: MAKITA CORPORATION, Anjo-shi (JP)

(21) Appl. No.: 15/445,142

(22) Filed: Feb. 28, 2017

(30) Foreign Application Priority Data
Apr. 8, 2016 (JP) 2016-078102
Jun. 20, 2016 (JP) 2016-122008

(51) Int. Cl. H02J 7/00

(52) U.S. Cl. CPC H02J 7/0013; H02J 7/0044

(57) ABSTRACT

A charger terminal disclosed herein may include a first spring having one end fixed to a support structure; a bend extending from another end of the first spring and bending back at an angle of 90 degrees or more; and a second spring having one end extending from the bend, and another end configured capable of contacting the support structure. A charger configured to charge a battery pack disclosed herein may include the charger terminal. In the charger, the other end of the second spring may make contact with the support structure when the battery pack is set in the charger.

### TECHNICAL FIELD

The technique disclosed herein relates to a charger terminal and a charger.

### BACKGROUND

Japanese Patent Application Publication No. 2009-5517 discloses a charger configured to charge a battery pack. In this charger, plural types of battery packs may be charged.

### SUMMARY

In a charger that can charge plural types of battery packs, there is a case where when a certain type of battery pack is set, a specific charger terminal provided in the charger makes contact with a terminal of the battery pack, and when another type of battery pack is set, this specific charger terminal makes contact with a casing of the battery pack. For example, a first intermediate voltage input terminal 30 of a charger 10 disclosed in Japanese Patent Application Publication No. 2009-5517 makes contact with a first intermediate voltage terminal 244 of a second battery pack 200 when the second battery pack 200 is set, and makes contact with a casing 102 of a first battery pack 100 when the first battery pack 100 is set.

FIGS. 20 and 21 show an example of a charger terminal that makes contact with a terminal of a battery pack or makes contact with a casing of a battery pack as above, depending on types of the battery pack to be set. A charger 300 shown in FIGS. 20 and 21 includes charger terminals 302. As shown in FIG. 20, when a first type of battery pack 400 is inserted, the charger terminals 302 make contact with terminals 402 of the battery pack 400. As shown in FIG. 21, when a second type of battery pack 500 is inserted, the charger terminals 302 make contact with a casing 502 of the battery pack 500. FIGS. 22 and 23 show a shape of one charger terminal 302 that has conventionally been used. As shown in FIGS. 20 and 21, the charger terminal 302 shown in FIGS. 22 and 23 is fixed by being suspended on an upper end of a support wall 304 inside the charger 300, and when the battery pack 400 or the battery pack 500 is set on the charger 300, a portion of each charger terminal 302 starting from where it is fixed to the upper end of the support wall 304 to a contact point with the battery pack 400 or the battery pack 500 functions as one spring.

With such charger terminals 302, as shown in FIG. 21, the charger terminals 302 deform greatly when they make contact with the casing 502 of the battery pack 500, and there is a risk that a large stress acts on the charger terminals 302 that would generate plastic deformation. In order to prevent such a plastic deformation, the shape of the charger terminals 302 needs to be changed to reduce the stress acting on the charger terminals 302 upon their contact with the casing 502 of the battery pack 500. However, if the stress acting on the charger terminals 302 upon their contact with the casing 502 of the battery pack 500 is reduced, a stress acting on the charger terminals 302 upon their contact with the terminals 402 of the battery pack 400, as shown in FIG. 20, would also become reduced. As a result of this, contact pressure applied on the terminals 402 of the battery pack 400 by elastic restoration force from the charger terminals 302 is reduced, and it becomes difficult to ensure an electric connection between the terminals. A technique that can ensure contact pressure for a terminal of a battery pack even in the event of reducing a stress acting on a charger terminal is being demanded.

The technique described herein provides a solution to the aforementioned situation. The disclosure herein provides the technique that can ensure contact pressure for a terminal of a battery pack even when a stress acting on a charger terminal is reduced.

A charger terminal disclosed herein may comprise: a first spring having one end fixed to a support structure; a bend extending from another end of the first spring and bending back at an angle of 90 degrees or more; and a second spring having one end extending from the bend, and another end configured capable of contacting the support structure.

In the above charger terminal, contact pressure for the terminal of the battery pack can be ensured even in the event of having reduced the stress acting on the charger terminal when the battery pack is set, due to the first and second springs respectively exerting elastic restoration force between a contact point with the battery pack and the support structure. Further, since the bend is bent back at the angle of 90 degrees or more, the charger terminal can be downsized as compared to a case where the bend is bent back at an angle less than 90 degrees.

The disclosure herein also discloses a charger configured to charge a battery pack. The charger comprises the aforementioned charger terminal. In this charger, the other end of the second spring makes contact with the support structure when the battery pack is set in the charger.

In the above charger, the first and second springs of the charger terminal respectively exert the elastic restoration force when the battery pack is set. Thus, the contact pressure for the terminal of the battery pack can be ensured even in the event of having reduced the stress acting on the charger terminal when the battery pack is set.

### BRIEF DESCRIPTION OF DRAWINGS

FIG. 1 is a perspective view showing outer appearances of a charger 2 and a battery pack 100, 200 of a present embodiment;

FIG. 2 is a perspective view showing the outer appearance of the battery pack 100 of the present embodiment;

FIG. 3 is a perspective view showing the outer appearance of the battery pack 200 of the present embodiment;

FIG. 4 is a cross sectional view showing a battery pack receiver 8 of the charger 2 of the present embodiment;

FIG. 5 is a top view showing the battery pack receiver 8 of the charger 2 of the present embodiment;

FIG. 6 is a perspective view showing a state in which an upper housing 602 of the charger 2 of the present embodiment is detached;

FIG. 7 is a perspective view seeing a battery box 606 of the present embodiment from below;

FIG. 8 is a perspective view showing a distal end of a support column 623 of the present embodiment;

FIG. 9 is a perspective view showing a state in which the upper housing 602 and the battery box 606 of the charger 2 of the present embodiment are detached;

FIG. 10 is a top view showing a power cable retainer 632 of the present embodiment;

FIG. 11 is a cross sectional view showing a state indicator 601 of the present embodiment;

FIG. 12 is a cross sectional view showing a state in which the battery pack 100 is set in the charger 2 of the present embodiment;

FIG. 13 is a cross sectional view showing a state in which the battery pack 200 is set in the charger 2 of the present embodiment;

FIG. 14 is a perspective view showing an outer appearance of an intermediate voltage detecting terminal 16 of the present embodiment;

FIG. 15 is a font view showing the intermediate voltage detecting terminal 16 of the present embodiment;

FIG. 16 is a side view showing the intermediate voltage detecting terminal 16 of the present embodiment;

FIG. 17 is a top view showing the intermediate voltage detecting terminal 16 of the present embodiment;

FIG. 18 is a perspective view showing an outer appearance of an intermediate voltage detecting terminal 16′ of a variant;

FIG. 19 is a side view showing the intermediate voltage detecting terminal 16′ of the variant;

FIG. 20 is a cross sectional view showing a state in which a first type of battery pack 400 is set in a charger 300 of a conventional technique;

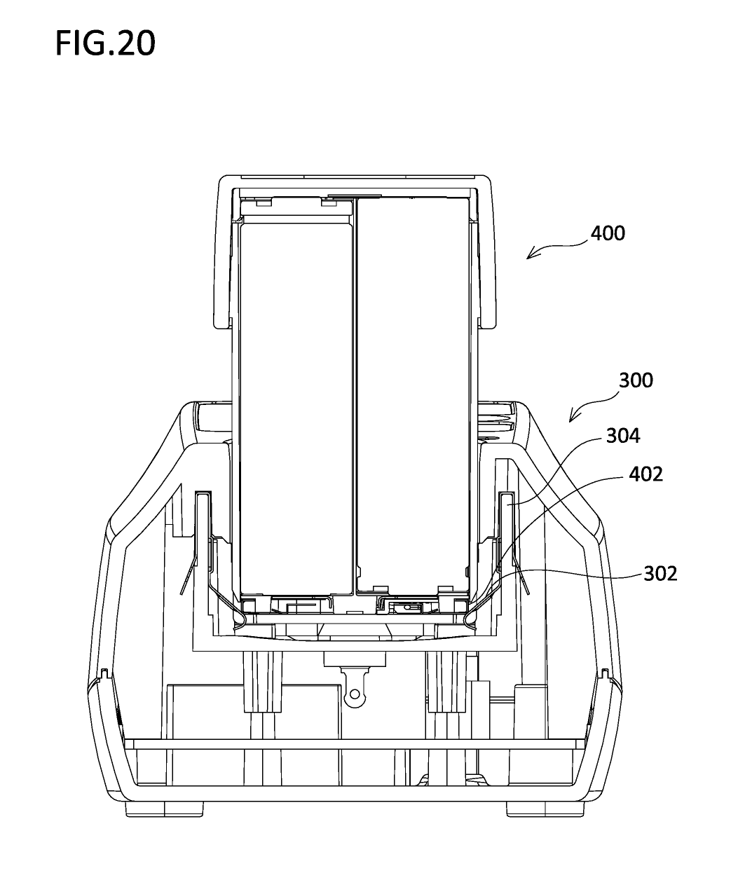

FIG. 21 is a cross sectional view showing a state in which a second type of battery pack 500 is set in the charger 300 of the conventional technique;

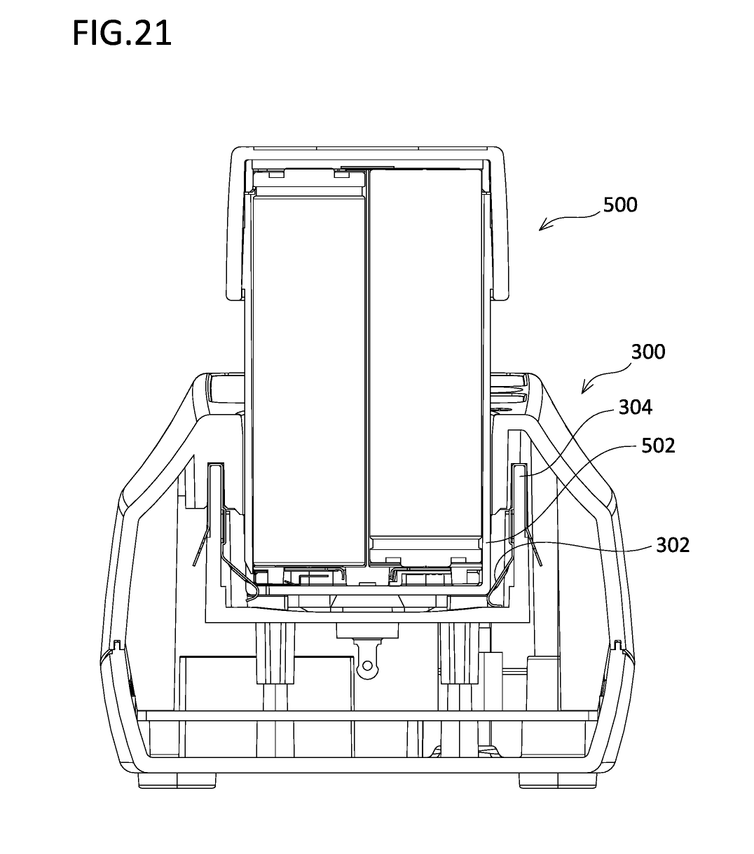

FIG. 22 is a perspective view showing an outer appearance of a charger terminal 302 of the conventional technique; and

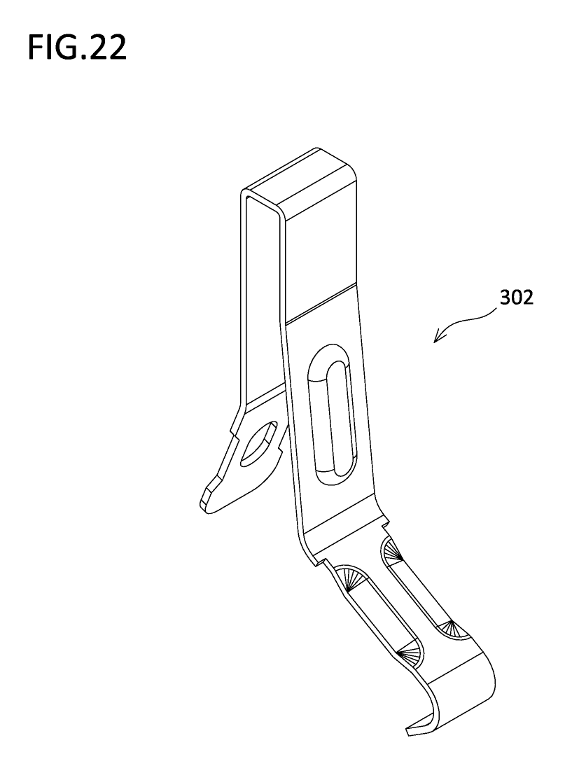

FIG. 23 is a side view showing the charger terminal 302 of the conventional technique.

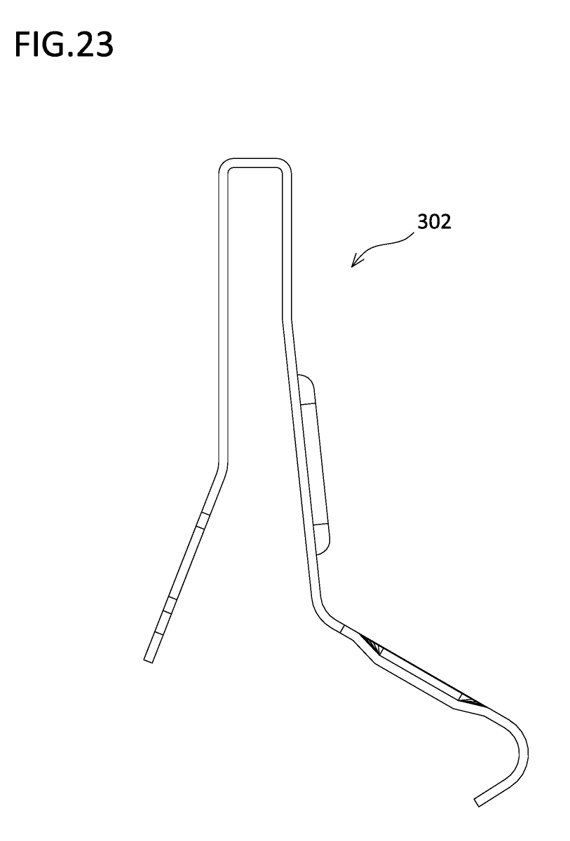

### DETAILED DESCRIPTION

In one or more embodiments, in the above charger terminal, the bend may bend back at an angle of 180 degrees or more.

According to the above configuration, since the bend is bent back at the angle of 180 degrees or more, a charger terminal can be downsized as compared to a case where the bend is bent back at an angle less than 180 degrees.

In one or more embodiments, in the above charger terminal, the second spring may comprise a gap that is larger than a width of the first spring, and the first spring and the second spring may be configured so as not to interfere with each other upon elastic deformation of the charger terminal.

When the bent-back angle of the bend is increased, there is a risk that the first and second springs interfere with each other when the charger terminal elastically deforms. In the above charger terminal, the interference of the first spring with the second spring upon the elastic deformation can be avoided by providing the gap that is larger than the width of the first spring on the second spring.

### Embodiment

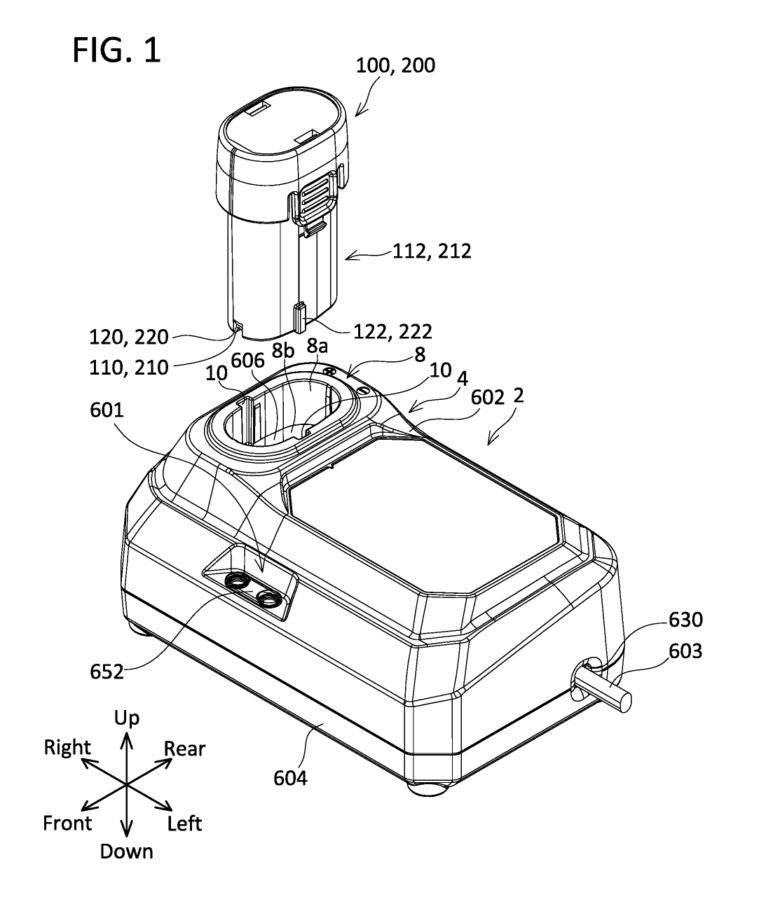

A charger 2 of an embodiment will be described with reference to the drawings. The charger 2 shown in FIG. 1 is configured to charge plural types of battery packs 100, 200.

(Configurations of Battery Packs 100, 200)

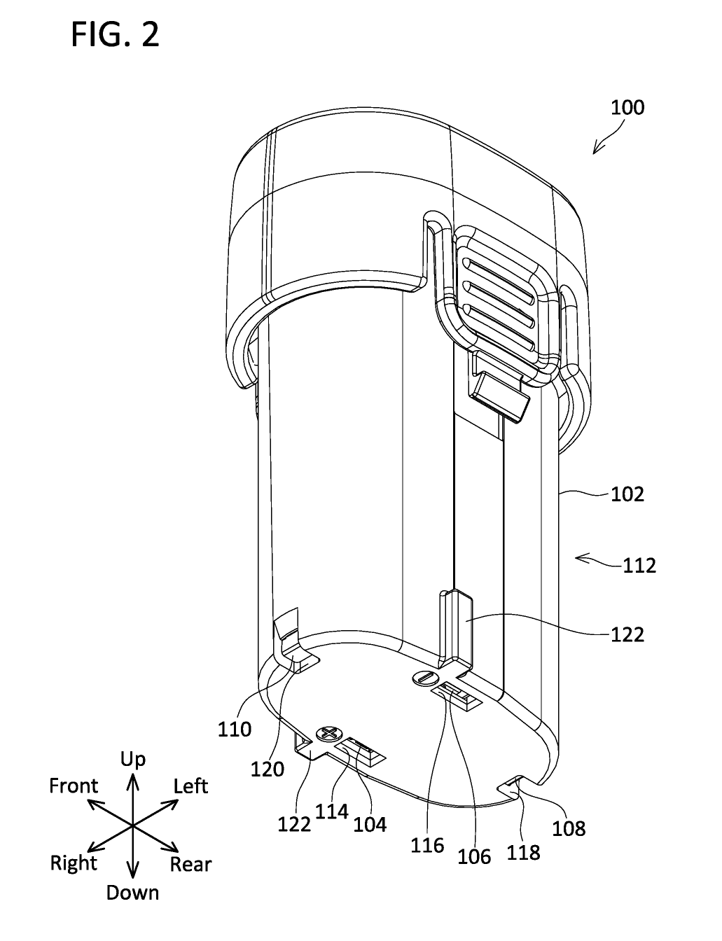

FIG. 2 shows an outer appearance of a first type of battery pack 100. The first type of battery pack 100 houses, inside its casing 102, two columnar battery cells (not shown), a heat sensing element (not shown), a positive terminal 104, a negative terminal 106, an intermediate voltage detecting terminal 108, and a temperature detecting terminal 110. The two battery cells are, for example, lithium ion battery cells. Inside the casing 102, the two battery cells are arranged parallel to each other. Inside the casing 102, a negative side of one battery cell is connected to the negative terminal 106, a positive side of the one battery cell is connected to a negative side of the other battery cell, and a positive side of the other battery cell is connected to the positive terminal 104. That is, the two battery cells are connected electrically in series between the positive terminal 104 and the negative terminal 106. The intermediate voltage detecting terminal 108 is connected to a connecting point between the positive side of the one battery cell and the negative side of the other battery cell inside the casing 102. The temperature detecting terminal 110 is connected to the negative terminal 106 via the beat sensing element inside the casing 102. The heat sensing element is, for example, a thermistor of which resistance value changes according to temperature.

A lower part of the battery pack 100 constitutes an insert 112 for inserting the battery pack 100 into the charger 2 or a power tool (not shown). At the insert 112, the casing 102 has an outer shape of which cross section has an elongated columnar shape. At the insert 112, the casing 102 is provided with a positive terminal hole 114 provided corresponding to the positive terminal 104, a negative terminal hole 116 provided corresponding to the negative terminal 106, an intermediate voltage detecting terminal hole 118 provided corresponding to the intermediate voltage detecting terminal 108, and a temperature detecting terminal hole 120 provided corresponding to the temperature detecting terminal 110. The positive terminal hole 114 and the negative terminal hole 116 are arranged on a bottom surface of the casing 102. The intermediate voltage detecting terminal hole 118 and the temperature detecting terminal hole 120 are arranged at corner portions which are formed by the bottom surface and a side surface of the casing 102, and are respectively located at both ends of the bottom surface of the casing 102 along a long direction thereof. Further, at the insert 112, a pair of guide ribs 122 is provided on the side surface of the casing 102 at positions slightly offset to one side (for example, to a front side) from a center of the bottom surface of the casing 102 along the long direction thereof.

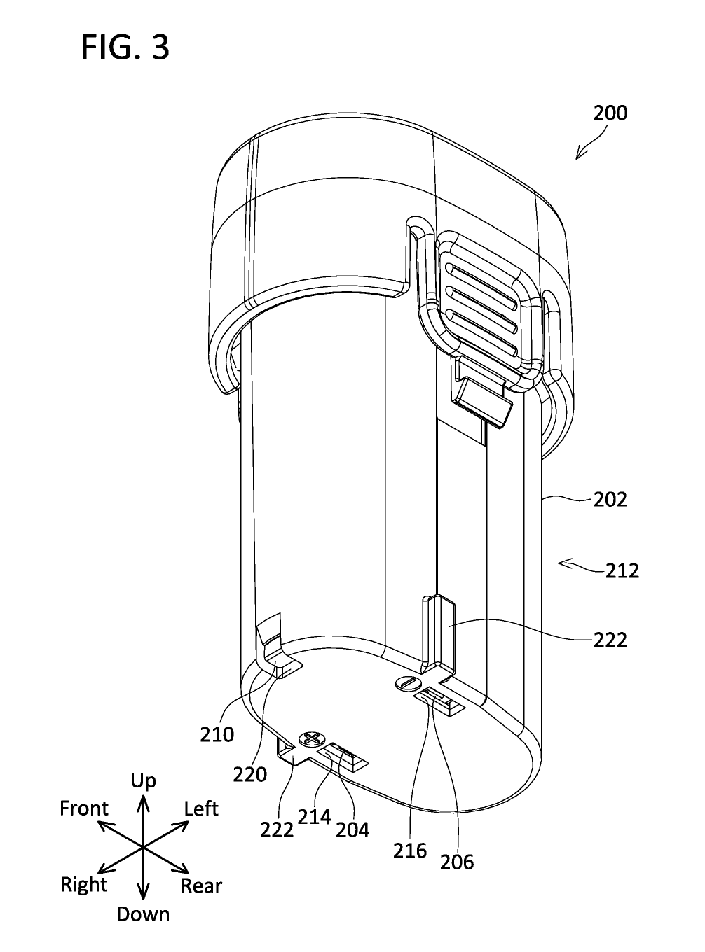

FIG. 3 shows an outer appearance of a second type of battery pack 200. The second type of battery pack 200 houses, inside its casing 202, two columnar battery cells (not shown), a heat sensing element (not shown), a positive terminal 204, a negative terminal 206, and a temperature detecting terminal 210. The two battery cells are, for example, lithium ion battery cells. Inside the casing 202, the two battery cells are arranged parallel to each other. Inside the casing 202, a negative side of one battery cell is connected to the negative terminal 206, a positive side of the one battery cell is connected to a negative side of the other battery cell, and a positive side of the other battery cell is connected to the positive terminal 204. That is, the two battery cells are connected electrically in series between the positive terminal 204 and the negative terminal 206. The temperature detecting terminal 210 is connected to the negative terminal 206 via the heat sensing element inside the casing 202. The heat sensing element is, for example, a thermistor of which resistance value changes according to temperature.

A lower part of the battery pack 200 constitutes an insert 212 for inserting the battery pack 200 into the charger 2 or a power tool (not shown). At the insert 212, the casing 202 has an outer shape of which cross section has an elongated columnar shape. At the insert 212, the casing 202 is provided with a positive terminal hole 214 provided corresponding to the positive terminal 204, a negative terminal hole 216 provided corresponding to the negative terminal 206, and a temperature detecting terminal hole 220 provided corresponding to the temperature detecting terminal 210. The positive terminal hole 214 and the negative terminal hole 216 are arranged on a bottom surface of the casing 202. The temperature detecting terminal hole 220 is arranged at a corner portion which is formed by the bottom surface and a side surface of the casing 202, and located at one end of the bottom surface of the casing 202 along a long direction thereof (for example, a front-side end). Further, at the insert 212, a pair of guide ribs 222 is provided on the side surface of the casing 202 at positions slightly offset to one side (for example, to a front side) from a center of the bottom surface of the casing 202 along the long direction thereof.

The first type of battery pack 100 shown in FIG. 2 and the second type of battery pack 200 shown in FIG. 3 differ only in that the first type of battery pack 100 comprises the intermediate voltage detecting terminal 108 and the intermediate voltage detecting terminal hole 118, whereas the second type of battery pack 200 does not comprise an intermediate voltage detecting terminal and an intermediate voltage detecting terminal hole, and they have same configurations regarding other portions. That is, the insert 112 of the first type of battery pack 100 and the insert 212 of the second type of battery pack 200 have an identical shape except for their presence/absence of the intermediate voltage detecting terminal 108 and the intermediate voltage detecting terminal hole 118. Positions where the positive terminal 104, the positive terminal hole 114, the negative terminal 106, the negative terminal hole 116, the temperature detecting terminal 110, the temperature detecting terminal hole 120, and the pair of guide ribs 122 are arranged in the first type of battery pack 100 and positions where the positive terminal 204, the positive terminal hole 214, the negative terminal 206, the negative terminal hole 216, the temperature detecting terminal 210, the temperature detecting terminal hole 220, and the pair of guide ribs 222 are arranged in the second type of battery pack 200 are identical.

(Configuration of Charger 2)

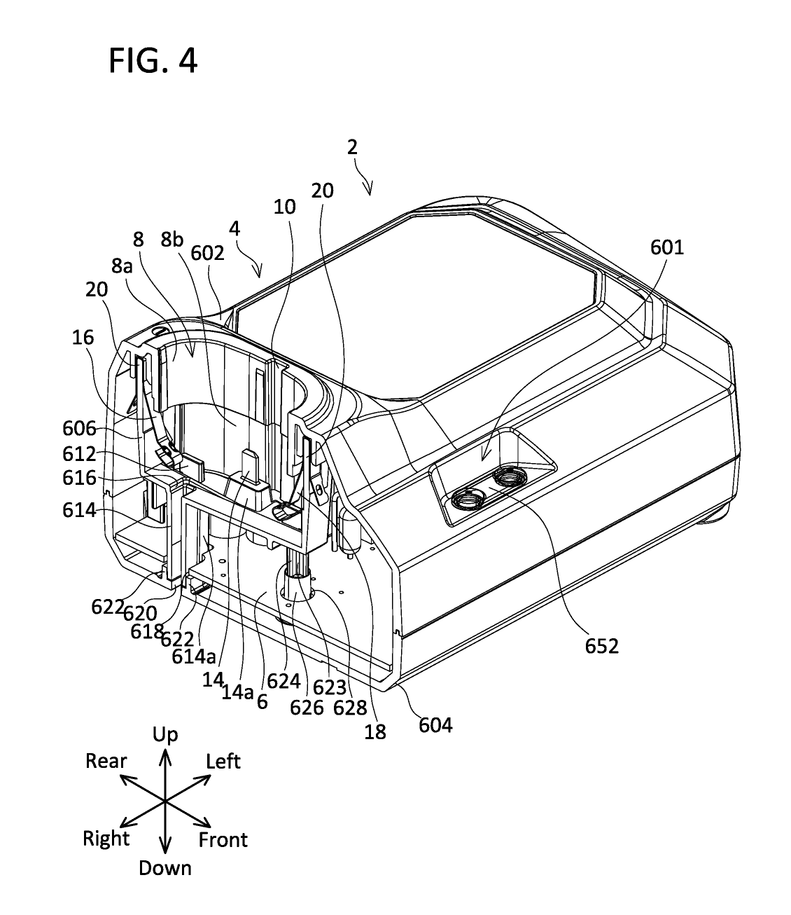

As shown in FIG. 1, the charger 2 comprises a housing 4, a charge controller 6 (see FIGS. 4, 6, and 9) housed in the housing 4, a state indicator 601, and a power cable 603. The housing 4 comprises an upper housing 602, a lower housing 604, and a battery box 606. The upper housing 602, the lower housing 604, and the battery box 606 are components made of resin. The housing 4 is provided with a battery pack receiver 8 constituted by the upper housing 602 and the battery box 606 for inserting the battery pack 100, 200.

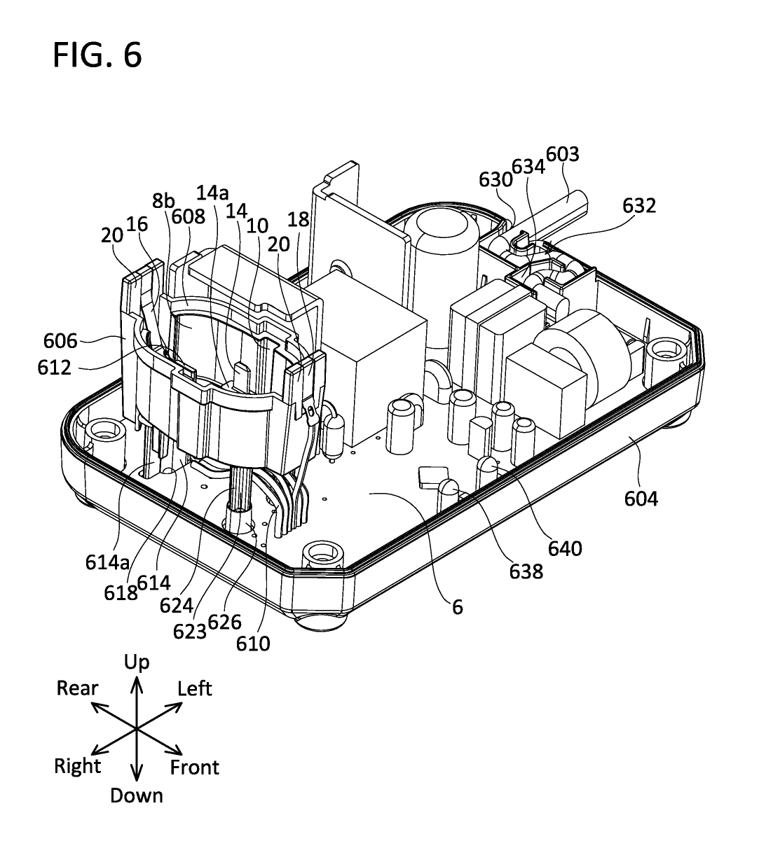

The battery pack receiver 8 has its cross section in an elongated columnar and concave shape corresponding to the cross sections of the inserts 112, 212 of the battery packs 100, 200. An upper portion 8a of the battery pack receiver 8 is constituted of the upper housing 602, and a lower portion 8b of the battery pack receiver 8 is constituted of the battery box 606. As shown in FIG. 6, the battery box 606 is provided with a surrounding wall 608 that extends upward from the lower portion 8b of the battery pack receiver 8 and surrounds an outer side of the upper portion 8a of the battery pack receiver 8. The surrounding wall 608 prevents water from entering inside the housing 4 from a gap between the upper portion 8a and the lower portion 8b of the battery pack receiver 8. As shown in FIG. 4, each of the upper portion 8a and the lower portion 8b of the battery pack receiver 8 has a pair of guide grooves 10 provided corresponding to the pairs of guide ribs 122, 222 of the battery packs 100, 200. When the battery pack 100 or 200 is to be inserted in its correct orientation along a front-and-rear direction into the battery pack receiver 8, the pair of guide ribs 122 or 222 and the pair of guide grooves 10 match in their positions, so the battery pack 100, 200 can be inserted into the battery pack receiver 8 with the pair of guide ribs 122 or 222 entering into the pair of guide grooves 10. When the battery pack 100 or 200 is to be inserted in an incorrect orientation along the front-and-rear direction into the battery pack receiver 8, the pair of guide ribs 122 or 222 and the pair of guide grooves 10 do not match in their positions, so the battery pack 100, 200 cannot be inserted into the battery pack receiver 8.

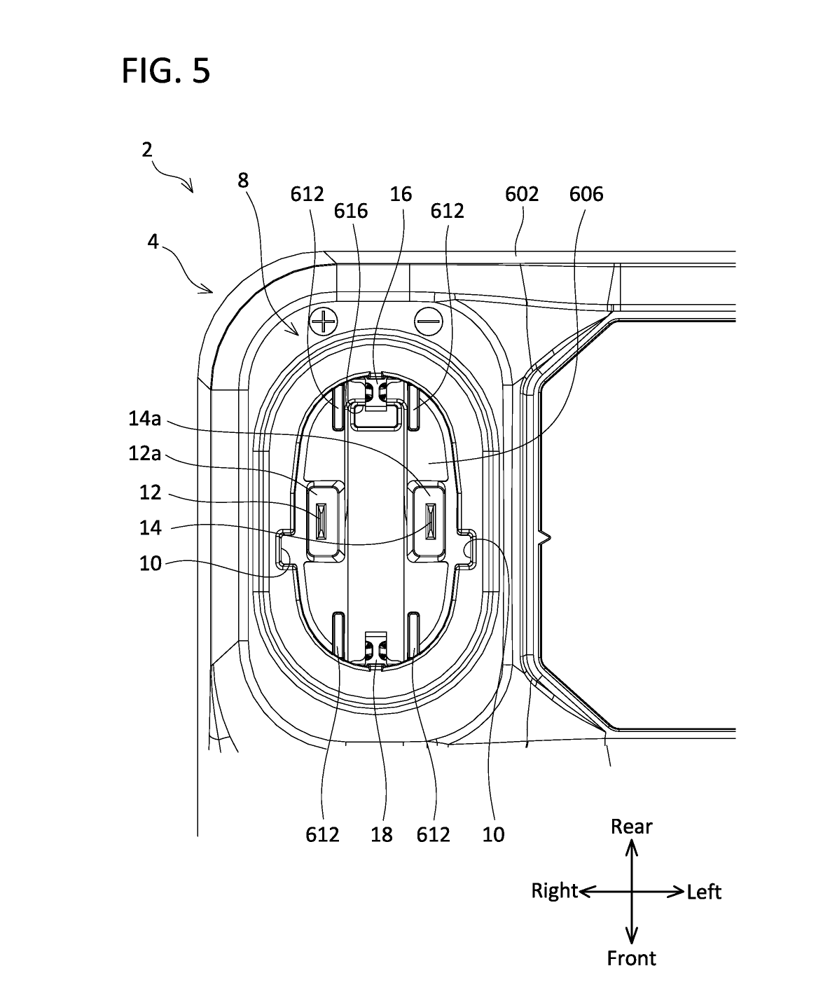

As shown in FIG. 5, a charger positive terminal 12 and a charger negative terminal 14 are arranged at a bottom of the battery pack receiver 8, that is, at a bottom of the battery box 606. The charger positive terminal 12 and the charger negative terminal 14 are components made of metal, and are configured integrally with the battery box 606 by insert molding. The charger positive terminal 12 and the charger negative terminal 14 respectively connect to the charge controller 6 via wires 610 (see FIG. 6). The charger positive terminal 12 and the charger negative terminal 14 are a pair of rectangular plate-like terminals extending upward and parallel to each other, respectively from a positive terminal stage 12a and a negative terminal stage 14a provided at the bottom of the battery box 606. The positive terminal stage 12a and the negative terminal stage 14a each have a shape that bulges upward from the bottom of the battery box 606. Thus, even if a water puddle is generated at the bottom of the battery box 606, the charger positive terminal 12 and the charger negative terminal 14 can be prevented from being immersed in water. The charger positive terminal 12 is arranged at a position corresponding to the positive terminals 104, 204 of the battery packs 100, 200. The charger negative terminal 14 is arranged at a position corresponding to the negative terminals 106, 206 of the battery packs 100, 200. When the battery pack 100 or 200 is set in the battery pack receiver 8, the charger positive terminal 12 penetrates the positive terminal hole 114 or 214 of the corresponding battery pack 100, 200 and engages with the corresponding positive terminal 104, 204, and the charger negative terminal 14 penetrates the negative terminal hole 116 or 216 of the corresponding battery pack 100, 200 and engages with the corresponding negative terminal 106, 206. Due to this, an electric connection between the charger positive terminal 12 and the positive terminal 104 or 204 is established, and an electric connection between the charger negative terminal 14 and the negative terminal 106 or 206 is established. Notably, as shown in FIGS. 4 and 5, the bottom of the battery box 606 is provided with a stopper 612 to which a bottom surface of the casing 102 or 202 makes contact when the battery pack 100 or 200 is inserted. The stopper 612 has a shape that bulges upward from the bottom of the battery box 606. Thus, even if a water puddle is generated at the bottom of the battery box 606, the positive terminal 104, 204, the negative terminal 106, 206, the intermediate voltage detecting terminal 108, the temperature detecting terminal 110, 210 of the inserted battery pack 100, 200 can be prevented from being immersed in water.

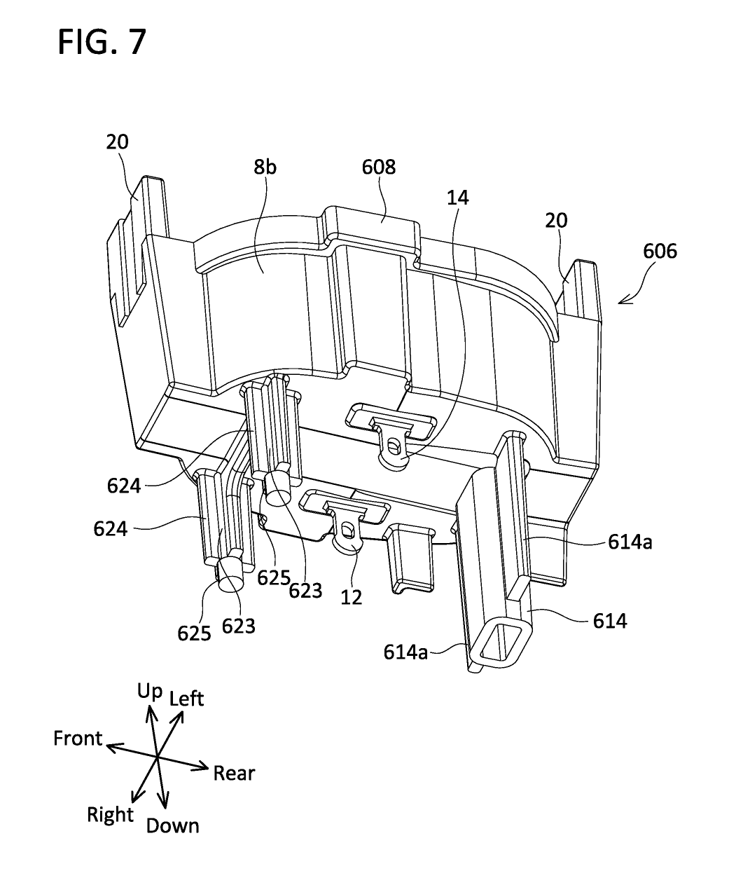

As shown in FIG. 4, a water drain hole 616 communicating with a water drain conduit 614 is provided at the bottom of the battery box 606 on a rearward side. As shown in FIG. 7, the water drain conduit 614 has a cross section that has a shape of an substantially elongate rectangular-shaped tube. Reinforcing ribs 614a are provided on a side surface of the water drain conduit 614. The water drain conduit 614 extends downward from a lower surface of the battery box 606. As shown in FIG. 6, in a state where the battery box 606 is attached to the lower housing 604, the water drain conduit 614 penetrates a water drain conduit penetrating hole 618 provided on the charge controller 6 and makes contact with an upper surface of the lower housing 604. As shown in FIG. 4, the lower housing 604 is provided with a water drain hole 620. In the state where the battery box 606 is attached to the lower housing 604, the water drain hole 616 of the battery box 606 communicates with the water drain hole 620 of the lower housing 604 through the water drain conduit 614. When water enters into the battery pack receiver 8, the water flows into the water drain conduit 614 from the water drain hole 616, and is discharged outside of the charger 2 through the water drain hole 620. Notably, a surrounding wall 622 that surrounds an outer side of the water drain conduit 614 when the battery box 606 is attached to the lower housing 604 is provided on the upper surface of the lower housing 604. The surrounding wall 622 prevents water from entering inside the housing 4 from a gap between the water drain conduit 614 and the upper surface of the lower housing 604.

As shown in FIG. 4, an intermediate voltage detecting terminal 16 and a temperature detecting terminal 18 are provided inside the battery pack receiver 8. As shown in FIG. 6, the intermediate voltage detecting terminal 16 and the temperature detecting terminal 18 respectively connect to the charge controller 6 via the wires 610. Each of the intermediate voltage detecting terminal 16 and the temperature detecting terminal 18 is fixed by being suspended on an upper end of a support wall 20 provided in the battery box 606. The intermediate voltage detecting terminal 16 is arranged at a position corresponding to the intermediate voltage detecting terminal 108 of the battery pack 100. The temperature detecting terminal 18 is arranged at a position corresponding to the temperature detecting terminals 110, 210 of the battery packs 100, 200.

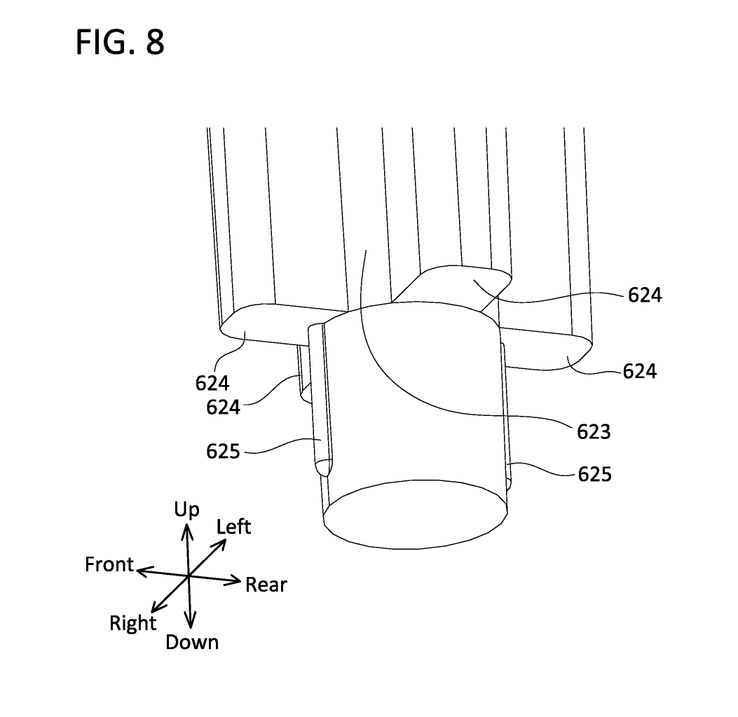

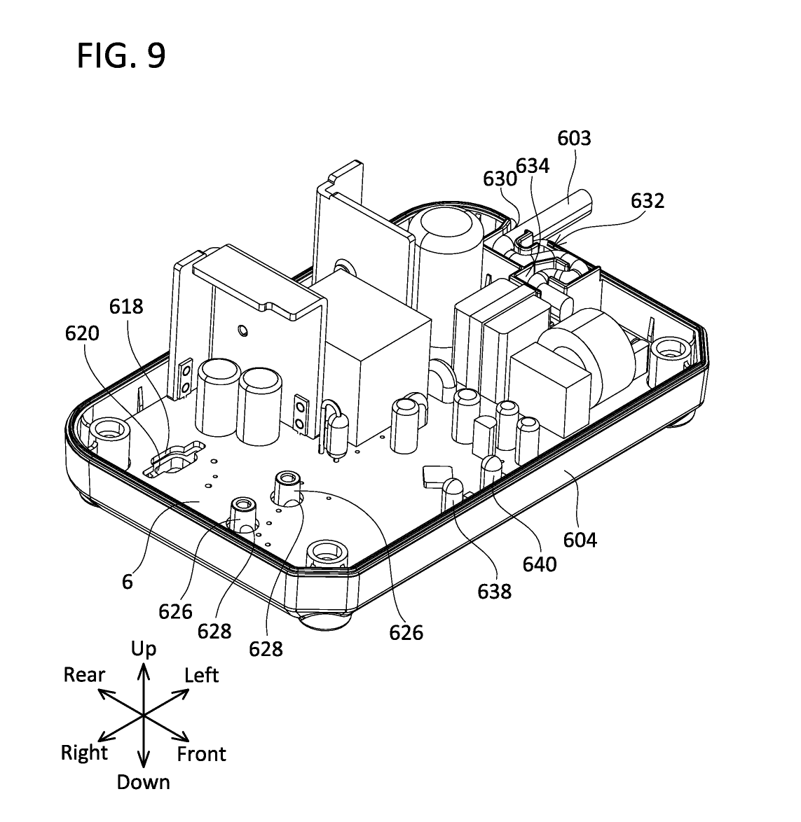

As shown in FIG. 7, a pair of support columns 623 is provided at a front lower portion of the battery box 606. The pair of support columns 623 has a round columnar shape, and extends downward from the lower surface of the battery box 606. Each support column 623 of the pair is provided with reinforcing ribs 624 and press-fitting ribs 625 (see FIG. 8). As shown in FIG. 9, the lower housing 604 has a pair of attaching stages 626 provided at positions corresponding to the pair of support columns 623. The pair of attaching stages 626 has a circular tubular shape, and extends upward from the upper surface of the lower housing 604. The pair of attaching stages 626 penetrates attaching stages penetrating holes 628 provided on the charge controller 6. As shown in FIG. 6, when the battery box 606 is to be attached to the lower housing 604, distal ends of the pair of support columns 623 are inserted into the pair of attaching stages 626 under a state where a lower end of the water drain conduit 614 is positioned with the water drain hole 620, and the battery box 606 is pressed in until the reinforcing ribs 624 make contact with the attaching stages 626. Due to this, the press-fitting ribs 625 at the distal ends of the pair of support columns 623 (see FIG. 8) are deformed, and the distal ends of the pair of support columns 623 are press-fitted into the pair of attaching stages 626. Due to the distal ends of the pair of support columns 623 being press-fitted into the pair of attaching stages 626, the battery box 606 can be avoided from being displaced upwardly by rigidity of the wires 610. Further, by facilitating the press fitting insertion by the small-sized press-fitting ribs 625, load required for the press fitting insertion can be reduced.

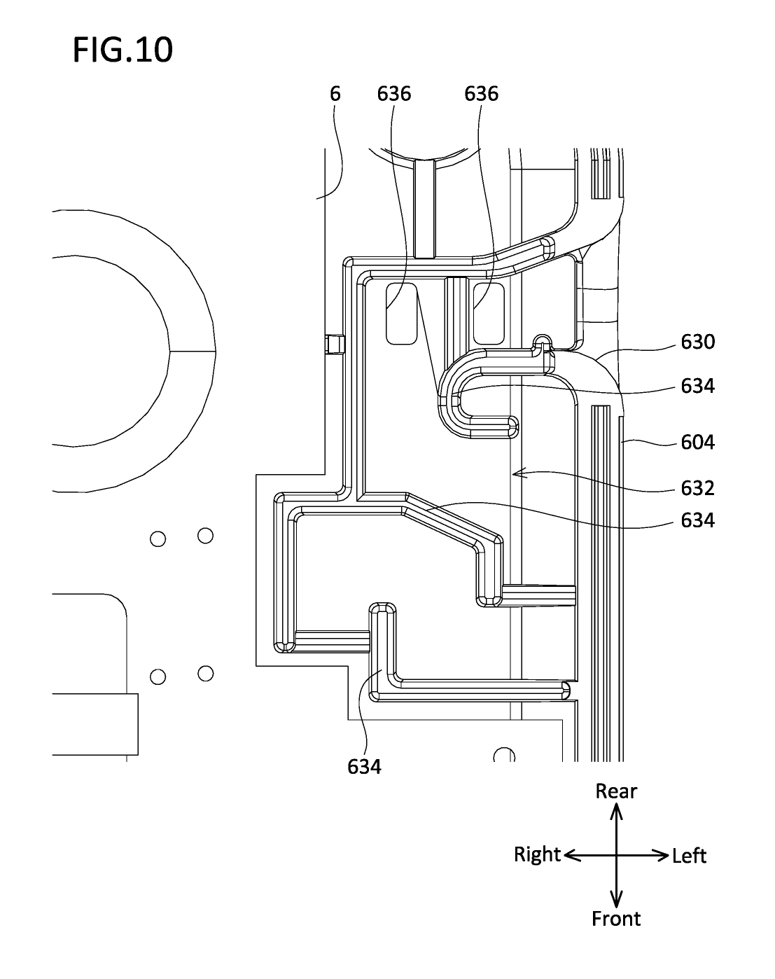

As shown in FIG. 1, the power cable 603 is inserted inside the housing 4 through a power cable insertion hole 630 provided on the upper housing 602 and the lower housing 604. As shown in FIG. 6, the power cable 603 is connected to the charge controller 6, and supplies power to the charger 2. As shown in FIGS. 6 and 9, a power cable retainer 632 is provided in a vicinity of the power cable insertion hole 630 of the lower housing 604. The power cable retainer 632 comprises a guide wall 634 that retains the power cable 603 while causing it to bend. The guide wall 634 extends upward from the upper surface of the lower housing 604. By retaining the power cable 603 with the power cable retainer 632, load will not be applied to a connecting portion between the power cable 603 and the charge controller 6 even if the power cable 603 is pulled outwardly. Further, as shown in FIG. 10, a portion of the lower housing 604 where the power cable retainer 632 is provided is provided with two water drain holes 636. Thus, even if water enters from the power cable insertion hole 630, the water will be discharged outside of the charger 2 through the water drain holes 636 of the power cable retainer 632.

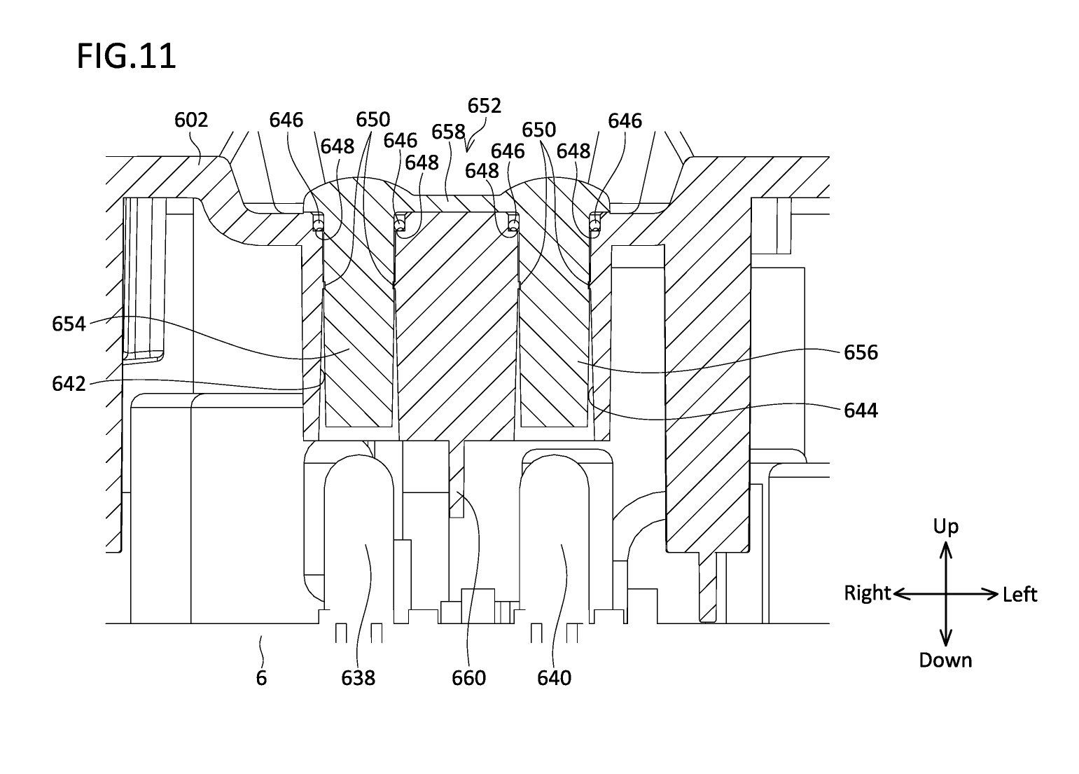

FIG. 11 shows a cross section of the state indicator 601. The state indicator 601 displays states of the charger 2 by light emission patterns of a first LED (light-emitting diode) 638 and a second LED 640 provided on the charge controller 6. For example, in the charger 2 of the present embodiment, the first LED 638 is a red LED, and the second LED 640 is a green LED. For example, in the charger 2 of the present embodiment, in a state where the power is supplied to the charger 2 through the power cable 603, and neither of the battery packs 100, 200 is set in the battery pack receiver 8, that is, when the charger 2 is in its standby state, the first LED 638 is turned off and the second LED 640 blinks. When the battery pack 100 or 200 is set in the battery pack receiver 8 and the charger 2 starts to charge the battery pack 100, 200, the first LED 638 is turned on and the second LED 640 is turned off. When an amount of charge in the battery pack 100, 200 exceeds 80% while the charger 2 is charging the battery pack 100, 200, the first LED 638 is turned on, and the second LED 640 is turned on. When the charger 2 completes the charge to the battery pack 100, 200, the first LED 638 is turned off and the second LED 640 is turned on. Notably, the light emission patterns of the first LED 638 and the second LED 640 as mentioned above are merely an example, and other light emitting patterns may display the states of the charger 2.

In the state indicator 601, the upper housing 602 is provided with two light guiding holes 642 and 644 respectively corresponding to the first LED 638 and the second LED 640. A sealing groove 648 on which a ring-shaped sealing member 646 such as an O-ring can be arranged is provided at each of the light guiding holes 642 and 644 in a vicinity of a surface of the upper housing 602. A ring-shaped press-fitting rib 650 is provided on an inner surface of each of the light guiding holes 642 and 644 at its intermediate portion in an up-and-down direction. Further, in the state indicator 601, a lens 652 is attached to the upper housing 602. The lens 652 is constituted of light permeating material. The lens 652 comprises two round columnar portions 654 and 656 respectively corresponding to the two light guiding holes 642 and 644, and a flat plate portion 658 for connecting upper ends of the two round columnar portions 654, 656. When the lens 652 is to be attached to the upper housing 602, the round columnar portions 654, 656 of the lens 652 are inserted into the light guiding holes 642, 644 under a state where the sealing members 646 are arranged on the sealing grooves 648, and the lens 652 is pressed in until the flat plate portion 658 makes contact with the surface of the upper housing 602. Due to this, the press-fitting ribs 650 on the inner surfaces of the light guiding holes 642, 644 are deformed, and the round columnar portions 654, 656 are press-fitted into the light guiding holes 642, 644. Due to the round columnar portions 654, 656 being press-fitted into the light guiding holes 642, 644, the lens 652 can be avoided from being displaced upwardly. Further, by facilitating the press fitting insertion by the small-sized press-fitting ribs 650, load required for the press fitting insertion can be reduced. Notably, the upper housing 602 is provided with a light shielding wall 660 extending downward between the first LED 638 and the second LED 640. The light shielding wall 660 prevents the light from the first LED 638 from entering to the round columnar portion 656 inserted in the light guiding hole 644, and also prevents the light from the second LED 640 from entering to the round columnar portion 654 inserted in the light guiding hole 642.

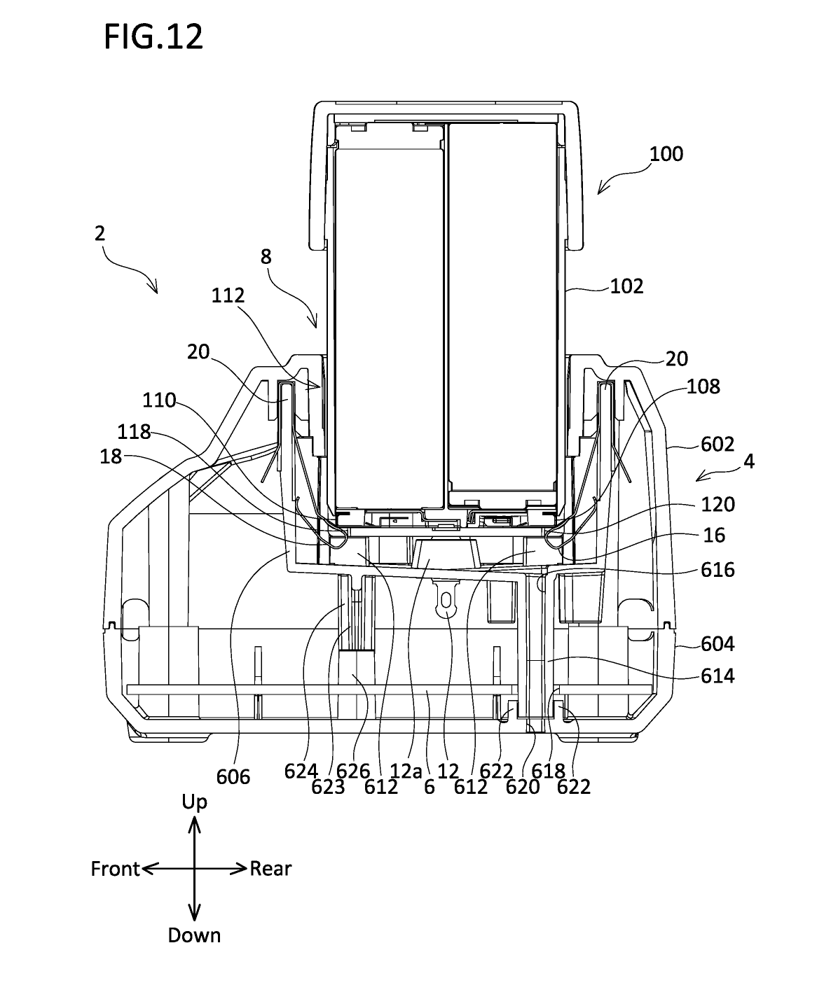

FIG. 12 shows a state in which the battery pack 100 is set in the battery pack receiver 8. In this case, the intermediate voltage detecting terminal 16 elastically deforms by making contact with the intermediate voltage detecting terminal 108 through the intermediate voltage detecting terminal hole 118. Contact pressure against the intermediate voltage detecting terminal 108 is ensured by elastic restoration force of the intermediate voltage detecting terminal 16, and an electric connection between the intermediate voltage detecting terminal 16 and the intermediate voltage detecting terminal 108 is thereby established. Further, the temperature detecting terminal 18 elastically deforms by making contact with the temperature detecting terminal 110 through the temperature detecting terminal hole 120. Contact pressure against the temperature detecting terminal 110 is ensured by elastic restoration force of the temperature detecting terminal 18, and an electric connection between the temperature detecting terminal 18 and the temperature detecting terminal 110 is thereby established.

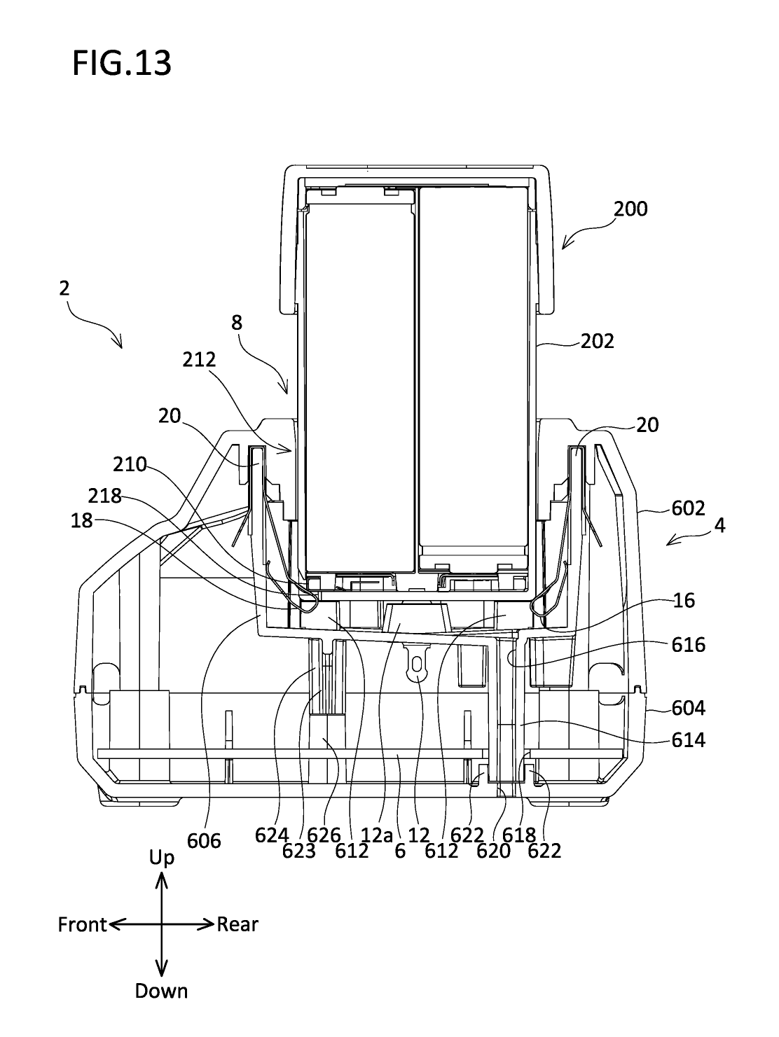

FIG. 13 shows a state in which the battery pack 200 is set in the battery pack receiver 8. In this case, the intermediate voltage detecting terminal 16 elastically deforms by making contact with a corner portion of the casing 202. Further, the temperature detecting terminal 18 elastically deforms by making contact with the temperature detecting terminal 210 through the temperature detecting terminal hole 220. Contact pressure against the temperature detecting terminal 210 is ensured by the elastic restoration force of the temperature detecting terminal 18, and an electric connection between the temperature detecting terminal 18 and the temperature detecting terminal 210 is thereby established.

(Configuration of Intermediate Voltage Detecting Terminal 16 and Temperature Detecting Terminal 18)

In the charger 2 of the present embodiment, the intermediate voltage detecting terminal 16 and the temperature detecting terminal 18 have an identical configuration. Thus, hereinbelow the intermediate voltage detecting terminal 16 will be described in detail as an example, and explanation on the temperature detecting terminal 18 will be omitted.

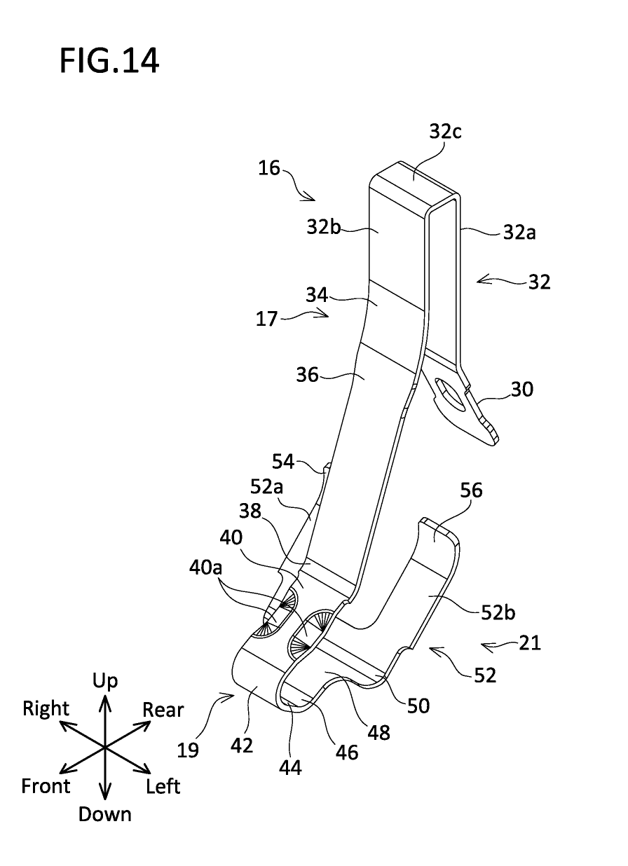

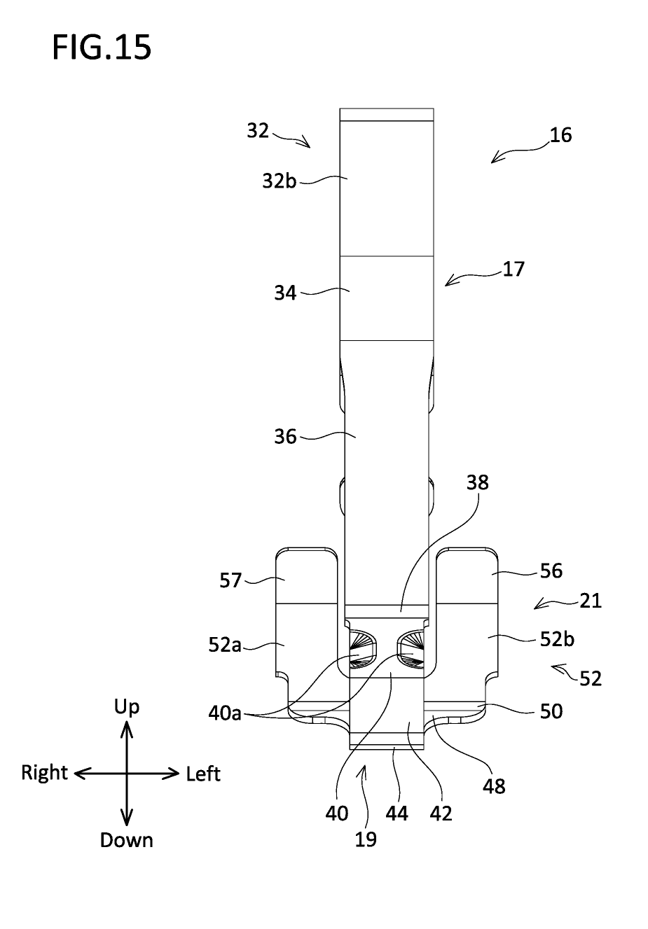

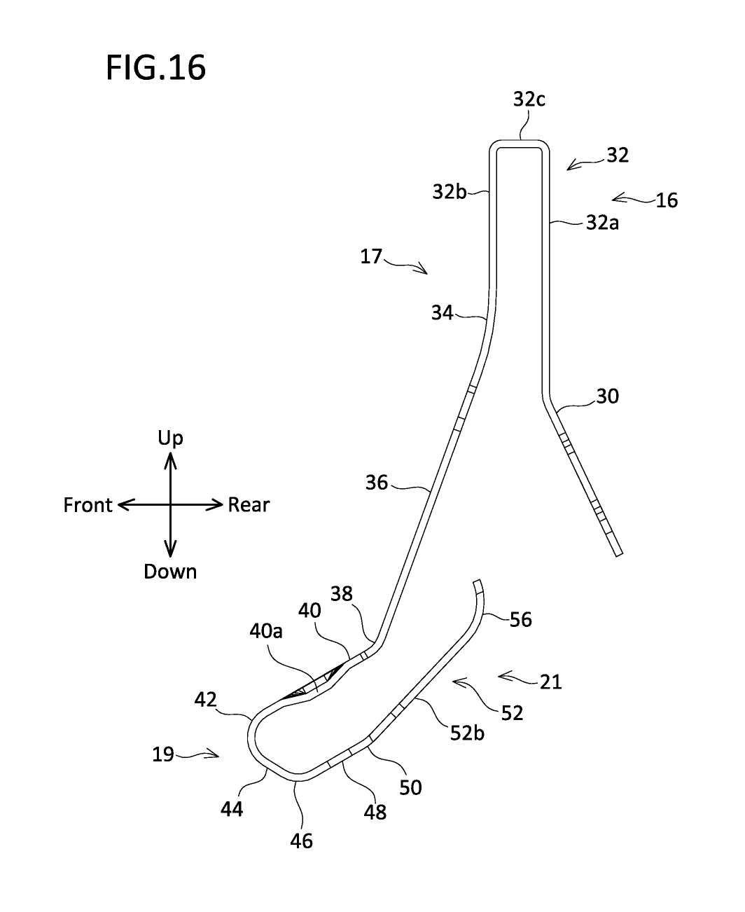

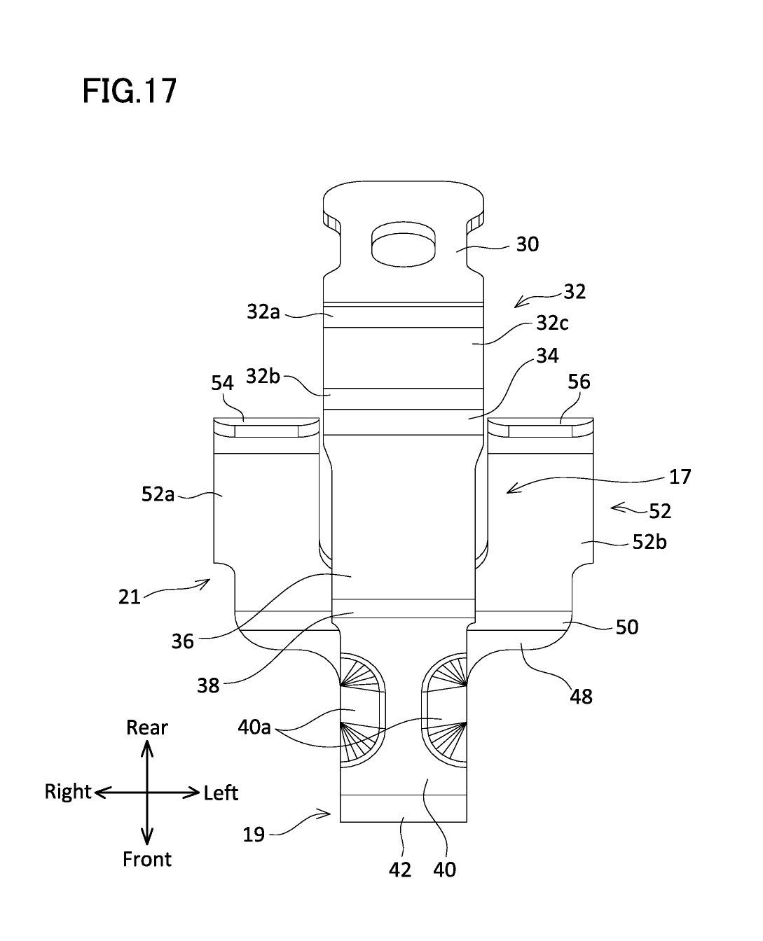

As shown in FIGS. 14 to 17, the intermediate voltage detecting terminal 16 comprises a connecting portion 30, a support portion 32, a first bent portion 34, a first straight portion 36, a second bent portion 38, a second straight portion 40, a third bent portion 42, a third straight portion 44, a fourth bent portion 46, a widened portion 48, a fifth bent portion 50, a forked portion 52, a sixth bent portion 54, and a seventh bent portion 56. The intermediate voltage detecting terminal 16 is fabricated by subjecting a piece of metal plate to various types of processing.

The connecting portion 30 is connected to one of the wires 610 from the charge controller 6 (see FIG. 6). The connecting portion 30 has its upper end coupled to a flat plate portion 32a of the support portion 32.

The support portion 32 comprises a pair of flat plate portions 32a, 32b that extends parallel to each other, and a coupling portion 32c that couples upper ends of the pair of flat plate portions 32a, 32b to each other. The support portion 32 has a shape that fits with the upper end of its corresponding support wall 20 of the battery box 606.

A lower end of the flat plate portion 32b of the support portion 32 is coupled to an upper end of the first straight portion 36 via the first bent portion 34. The first bent portion 34 is bent in a shape that projects inwardly as seen from the support wall 20. An angle that the first straight portion 36 forms relative to the flat plate portion 32b is, for example, 155 degrees to 165 degrees, and preferably is 159 degrees to 161 degrees.

A lower end of the first straight portion 36 is coupled to an upper end of the second straight portion 40 via the second bent portion 38. The second bent portion 38 is bent in a shape that projects inwardly as seen from the support wall 20. An angle that the second straight portion 40 forms relative to the first straight portion 36 is, for example, 135 degrees to 145 degrees, and preferably is 139 degrees to 141 degrees. Step portions 40a are provided on the second straight portion 40 on its both sides at positions in a vicinity of a center in its long direction. Rigidity of the second straight portion 40 is increased by providing the step portions 40a, and deformation of the second straight portion 40 can thereby be suppressed.

A lower end of the second straight portion 40 is coupled to an upper end of the third straight portion 44 via the third bent portion 42. The third bent portion 42 is bent in a shape that projects outwardly as seen from the support wall 20. An angle that the third straight portion 44 forms relative to the second straight portion 40 is, for example, 55 degrees to 65 degrees, and preferably is 59 degrees to 61 degrees.

A lower end of the third straight portion 44 is coupled to a lower end of the widened portion 48 via the fourth bent portion 46. The fourth bent portion 46 is bent in a shape that projects downwardly as seen from the support wall 20. An angle that the widened portion 48 forms relative to the third straight portion 44 is, for example, 115 degrees to 125 degrees, and preferably is 119 degrees to 121 degrees. The widened portion 48 has a shape of which width increases from the lower end toward its upper end.

The upper end of the widened portion 48 is coupled to a lower end of the forked portion 52 via the fifth bent portion 50. The fifth bent portion 50 is bent in a shape that projects inwardly as seen from the support wall 20. An upper end of the forked portion 52 is forked to a right forked portion 52a and a left forked portion 52b. A width of a gap between the right forked portion 52a and the left forked portion 52b is wide as compared to a width of each of the first straight portion 36, the second bent portion 38, and the second straight portion 40.

An upper end of the right forked portion 52a is coupled to a lower end of the sixth bent portion 54. An upper end of the left forked portion 52b is coupled to a lower end of the seventh bent portion 56. The sixth bent portion 54 and the seventh bent portion 56 are bent in a shape that projects inwardly as seen from the support wall 20. The sixth bent portion 54 and the seventh bent portion 56 can make contact with the support wall 20 when the intermediate voltage detecting terminal 16 deforms elastically. A width of a gap between the sixth bent portion 54 and the seventh bent portion 56 is wide as compared to the width of each of the first straight portion 36, the second bent portion 38, and the second straight portion 40.

The intermediate voltage detecting terminal 16 can be said as comprising a first spring 17, a bend 19, and a second spring 21. The first spring 17 is constituted of the support portion 32, the first bent portion 34, the first straight portion 36, the second bent portion 38, and the second straight portion 40. The bend 19 is constituted of the third bent portion 42, the third straight portion 44, and the fourth bent portion 46. The second spring 21 is constituted of the widened portion 48, the fifth bent portion 50, the forked portion 52, the sixth bent portion 54, and the seventh bent portion 56. The first spring 17 has its one end fixed to the support wall 20, which is a support structure. The bend 19 extends from the other end of the first spring 17, and bends back at an angle of 90 degrees or more, more specifically at an angle of 180 degrees or more. The second spring 21 has its one end extending from the bend 19, and its other end is configured capable of contacting the support wall 20.

When the battery pack 100 is inserted (see FIG. 12), the intermediate voltage detecting terminal 16 elastically deforms by the second straight portion 40 making contact with the intermediate voltage detecting terminal 108, and the sixth bent portion 54 and the seventh bent portion 56 thereby make contact with the support wall 20. In this case, between the contact point with the battery pack 100 and the support wall 20, the first spring 17 exerts elastic restoration force and the second spring 21 also exerts elastic restoration force. Thus, even when stress acting on the intermediate voltage detecting terminal 16 is reduced, the first spring 17 and the second spring 21 respectively exert their elastic restoration force between the contact point with the battery pack 100 and the support wall 20, so the contact pressure for the battery pack 100 onto the intermediate voltage detecting terminal 108 can be ensured.

Further, when the battery pack 200 is inserted (see FIG. 13), the intermediate voltage detecting terminal 16 elastically deforms by the second straight portion 40 making contact with the corner portion of the casing 202, and the sixth bent portion 54 and the seventh bent portion 56 thereby make contact with the support wall 20. In this case as well, the first spring 17 exerts its elastic restoration force and the second spring 21 also exerts its elastic restoration force between the contact point with the battery pack 200 and the support wall 20.

In the intermediate voltage detecting terminal 16 of the present embodiment, the bend 19 is bent back at the angle of 90 degrees or more. If the bend 19 is configured to bend back at an angle that is less than 90 degrees, a position where the second spring 21 makes contact with the support wall 20 would be lowered, and a size of the intermediate voltage detecting terminal 16 in the up-and-down direction would become large. By configuring the bend 19 to bend back at the angle of 90 degrees or more as in the intermediate voltage detecting terminal 16 of the present embodiment, the intermediate voltage detecting terminal 16 can be downsized.

Especially, in the intermediate voltage detecting terminal 16 of the present embodiment, the bend 19 is bent back at the angle of 180 degrees or more. By configuring as above, the size of the intermediate voltage detecting terminal 16 in the up-and-down direction can further be downsized as compared to a case where the bend 19 is bent back at an angle less than 180 degrees.

In the intermediate voltage detecting terminal 16 of the present embodiment, a gap that is larger than a width of the first spring 17 is provided in the second spring 21. Due to this, the first spring 17 and the second spring 21 can be prevented from interfering with each other when the intermediate voltage detecting terminal 16 elastically deforms.

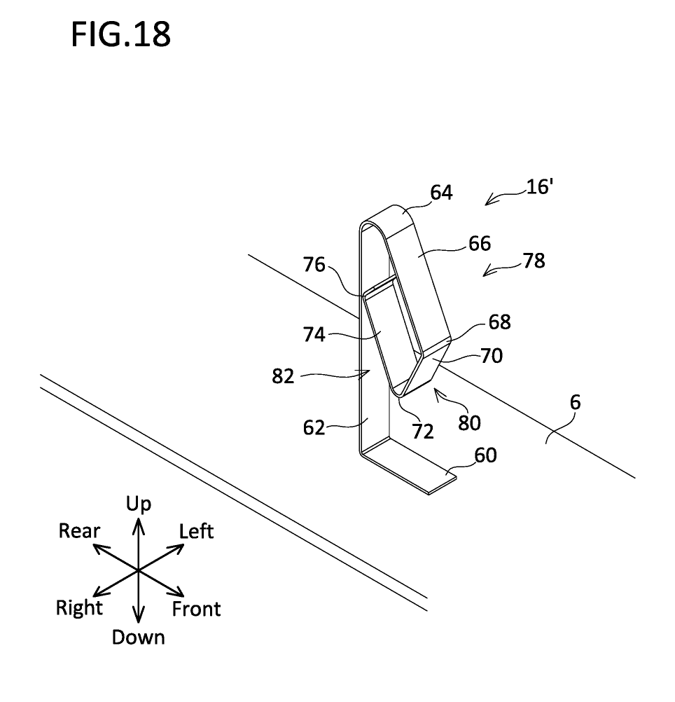

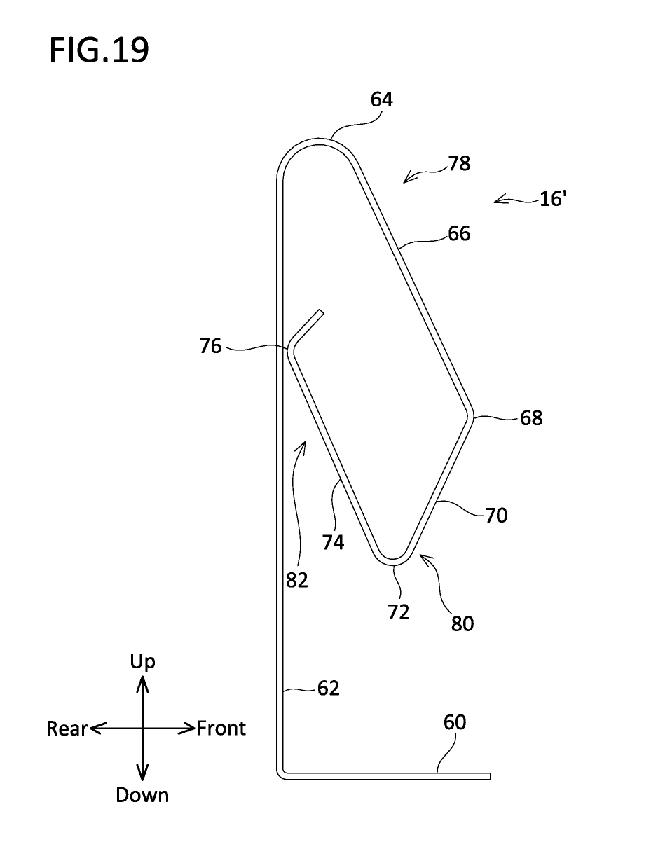

Notably, the intermediate voltage detecting terminal 16 (and the temperature detecting terminal 18) may have a shape as shown in FIGS. 18 and 19. Notably, in an example shown in FIGS. 18 and 19, the intermediate voltage detecting terminal 16 (and the temperature detecting terminal 18) are supported directly by the charge controller 6 instead of being supported by the support walls 20.

An intermediate voltage detecting terminal 16′ shown in FIGS. 18 and 19 comprises a connecting portion 60, a support portion 62, a first bent portion 64, a first straight portion 66, a second bent portion 68, a second straight portion 70, a third bent portion 72, a third straight portion 74, and a fourth bent portion 76.

The connecting portion 60 is fixed to an upper surface of the charge controller 6, and is electrically connected thereto. One end of the connecting portion 60 is coupled to a lower end of the support portion 62.

The support portion 62 extends vertically upward relative to the upper surface of the charge controller 6. An upper end of the support portion 62 is coupled to an upper end of the first straight portion 66 via the first bent portion 64. The first bent portion 64 is bent in a shape that projects upwardly as seen from the support portion 62. An angle that the first straight portion 66 forms relative to the support portion 62 is, for example, 20 degrees to 30 degrees, preferably 24 degrees to 26 degrees.

A lower end of the first straight portion 66 is coupled to an upper end of the second straight portion 70 via the second bent portion 68. The second bent portion 68 is bent in a shape that projects outwardly as seen from the support portion 62. An angle that the second straight portion 70 forms relative to the first straight portion 66 is, for example, 125 degrees to 135 degrees, preferably 129 degrees to 131 degrees.

A lower end of the second straight portion 70 is coupled to a lower end of the third straight portion 74 via the third bent portion 72. The third bent portion 72 is bent in a shape that projects downwardly as seen from the support portion 62. An angle that the third straight portion 74 forms relative to the second straight portion 70 is, for example, 45 degrees to 55 degrees, preferably 49 degrees to 51 degrees.

An upper end of the third straight portion 74 is coupled to a lower end of the fourth bent portion 76. The fourth bent portion 76 is bent in a shape that projects inwardly as seen from the support portion 62. The fourth bent portion 76 can make contact with the support portion 62 when the intermediate voltage detecting terminal 16′ deforms elastically.

The intermediate voltage detecting terminal 16′ shown in FIGS. 18 and 19 can be said as comprising a first spring 78, a bend 80, and a second spring 82. The first spring 78 is constituted of the first bent portion 64, the first straight portion 66, the second bent portion 68, and the second straight portion 70. The bend 80 is constituted of the third bent portion 72. The second spring 82 is constituted of the third straight portion 74 and the fourth bent portion 76. The first spring 78 has its one end fixed to the support portion 62 being a support structure. The bend 80 extends from the other end of the first spring 78, and bends back at an angle of 90 degrees or more, more specifically at an angle of 180 degrees or more. The second spring 82 has its one end extending from the bend 80, and its other end is configured capable of contacting the support portion 62.

When the battery pack 100 is inserted (see FIG. 12), the intermediate voltage detecting terminal 16′ shown in FIGS. 18 and 19 deforms elastically by the second bent portion 68 making contact with the intermediate voltage detecting terminal 108, and the fourth bent portion 76 thereby makes contact with the support portion 62. In this case, the first spring 78 exerts elastic restoration force and the second spring 82 also exerts elastic restoration force between the contact point with the battery pack 100 and the support portion 62. Thus, even when stress acting on the intermediate voltage detecting terminal 16′ is reduced, the first spring 78 and the second spring 82 respectively exert their elastic restoration force between the contact point with the battery pack 100 and the support portion 62, so the contact pressure for the battery pack 100 onto the intermediate voltage detecting terminal 108 can be ensured.

Further, when the battery pack 200 is inserted (see FIG. 13), the intermediate voltage detecting terminal 16′ shown in FIGS. 18 and 19 deforms elastically by the second bent portion 68 making contact with the corner portion of the casing 202, and the fourth bent portion 76 thereby makes contact with the support portion 62. In this case as well, the first spring 78 exerts the elastic restoration force and the second spring 82 also exerts the elastic restoration force between the contact point with the battery pack 200 and the support portion 62.

Notably, in the above embodiment, the explanation of the configuration in which the charger 2 can charge the battery pecks 100, 200 has been given, however, the charger 2 may be configured to charge a charging target that is other than a battery pack.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present disclosure or drawings provide technical utility either independently or through various combinations, and the present disclosure is not limited to the combinations described at the time the claims are filed. Further, the purpose of the examples illustrated by the present disclosure or drawings is to satisfy multiple objectives simultaneously, and satisfying any one of those objectives gives technical utility to the present disclosure.

1. A charger terminal comprising:
a first spring having one end fixed to a support structure;
a bend extending from another end of the first spring and bending back at an angle of 90 degrees or more; and
a second spring having one end extending from the bend, and another end configured capable of contacting the support structure.

2. The charger terminal according to claim 1, wherein
the bend bends back at an angle of 180 degrees or more.

3. The charger terminal according to claim 2, wherein
the second spring comprises a gap that is larger than a width of the first spring, and
the first spring and the second spring are configured so as not to interfere with each other upon elastic deformation of the charger terminal.

4. A charger configured to charge a battery pack, the charger comprising:
the charger terminal according to claim 1,
wherein the other end of the second spring makes contact with the support structure when the battery pack is set in the charger.
